(19) United States
(12) Patent Application Publication
(10) Pub. No.: US 2019/0195478 A1
(43) Pub. Date: Jun. 27, 2019

(54) LIGHTING APPARATUS INCLUDING A DISTANCE SENSOR FOR INDOOR PLANTS

(71) Applicant: Circuit Services, LLC, Northridge, CA (US)

(72) Inventors: Armen Hayrapetian, Northridge, CA (US); Artin Hayrapetian, Northridge, CA (US); Armen Terzikyan, Northridge, CA (US); GALUST C. YESAYAN, GLENDALE, CA (US); Garo Dardarian, Reseda, CA (US)

(73) Assignee: Circuit Services, LLC

(21) Appl. No.: 15/851,592

(22) Filed: Dec. 21, 2017

(51) Int. Cl. F21V 21/15; F21S 8/06; F21V 29/74; F21V 23/02; G08B 21/18; G08B 5/36; G05B 15/02; B66D 1/12; A01G 9/20

(52) U.S. Cl. CPC F21V 21/15; F21S 8/061; F21V 29/74; F21V 23/02; F21Y 2115/10; G08B 5/36; G05B 15/02; B66D 1/12; A01G 9/20; G08B 21/182

(57) ABSTRACT

A lighting apparatus includes a hanging assembly, the hanging assembly being adjustable in length, a light emitting diode (LED) assembly to project light onto one or more indoor plants, and a mounting plate, the mounting plate to attach to the hanging assembly. The lighting apparatus includes a power supply attached to the mounting plate and a sensor to determine a distance between the mounting plate and the one or more plants and communicate the determined distance. The lighting apparatus includes a comparison device to analyze the determined distance to identify if the determined distance is outside a pre-determined range, and to generate a signal to identify an out-of-range condition of the one or more indoor plants with respect to the mounting plate. The lighting apparatus includes an indicator to receive the signal identifying the out-of-range condition and to display a visual indicator that an out-of-range condition occurred.

### FIELD OF INVENTION

This patent disclosure relates to lighting devices for plants and to improved lighting devices for indoor plants.

### BACKGROUND OF INVENTION

Many more plants are being grown in indoor environments such as warehouses, rooms and/or greenhouses (which do not have access to sunlight). Due to downturns in local economies and/or a national economy, there is an abundance of indoor space such as empty warehouses and/or office buildings that may be equipped to begin growing indoor plants. However, these office buildings and/or warehouses are equipped with fixed lighting assemblies that may not lead to optimal growing conditions.

### BRIEF DESCRIPTION OF THE DRAWINGS

FIG. 1A illustrates an improved lighting apparatus with distance sensor for use in indoor plant growing environments according to embodiments;

FIG. 1B illustrates a bottom view of a lighting apparatus according to embodiments;

FIG. 1C illustrates an alternative version of an LED assembly according to embodiments;

FIG. 1D illustrates a block diagram of a lighting apparatus according to embodiments;

FIG. 2A illustrate a hanging assembly or mounting assembly including a reel assembly positioned near a power supply according to embodiments;

FIG. 2B illustrate a hanging assembly or mounting assembly including a reel assembly positioned near a power supply according to embodiments;

FIG. 2C illustrates a block diagram of a hanging assembly or mounting assembly according to embodiments;

FIG. 3A illustrates a lighting apparatus including adjustment occurring closer to a ceiling of an indoor building according to embodiments;

FIG. 3B illustrates a lighting apparatus including adjustment occurring closer to a ceiling of an indoor building according to embodiments;

FIG. 3C illustrates a block diagram of a mounting assembly or handing assembly according to embodiments;

FIG. 4 illustrates a computing device (e.g., a mobile computing device) interfacing with a lighting apparatus according to embodiments;

FIG. 5 illustrates a flowchart of a lighting apparatus operation according to embodiments;

FIG. 6 illustrates a block diagram of automatic adjustment devices in a lighting apparatus including an adjustment assembly or winching assembly according to embodiments; and

FIG. 7 illustrates a lighting apparatus comprising additional sensors, a spraying apparatus or one or more imaging devices according to embodiments.

### DETAILED DESCRIPTION

In embodiments, an improved lighting assembly may be utilized for providing light and energy in indoor plant growing environments. Indoor plants, including but not limited to cannabis and other legal indoor plants, need light and water in order to thrive and grow. In embodiments, a lighting assembly may be placed or hung from a ceiling over one or more indoor plants. However, as a plant grows, the plant may get too close to a lighting element of a lighting assembly. This may damage the indoor plant if the irradiation and/or intensity of the lighting assembly is too close to the indoor plants. In addition, an indoor plant having a large height may block out other indoor plants from receiving light when the other indoor plants are also receiving light from the same lighting assembly.

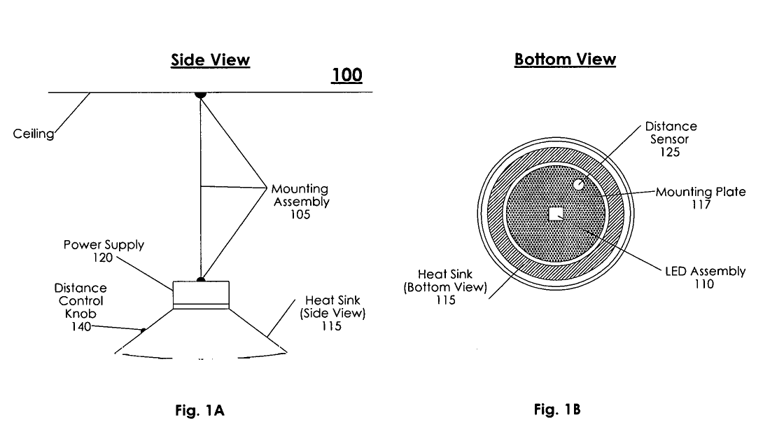

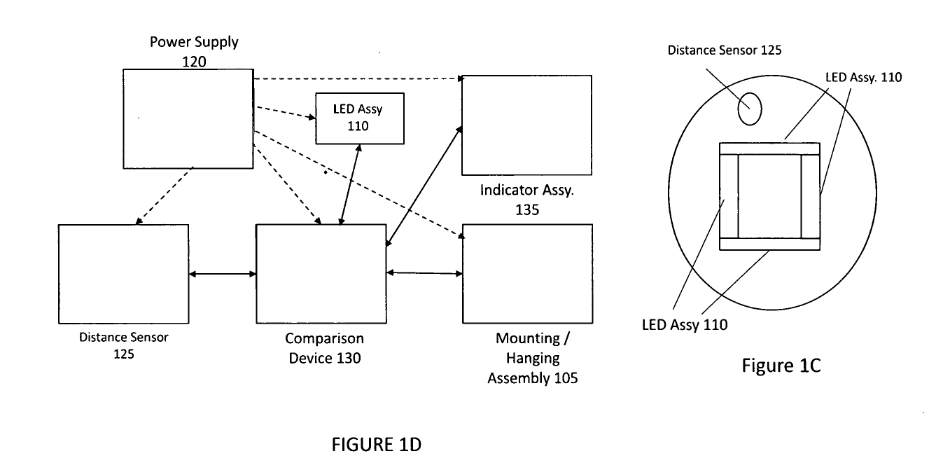

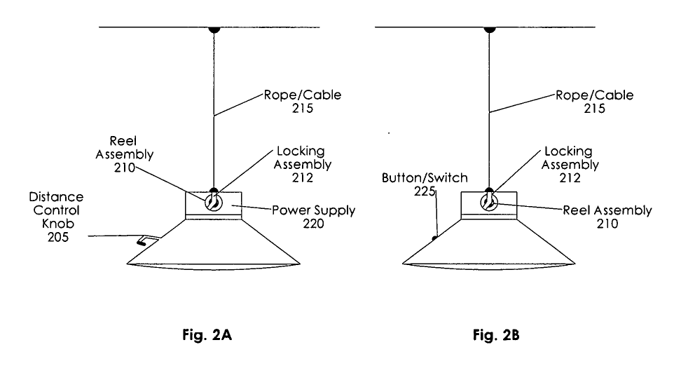

FIG. 1A illustrates an improved lighting apparatus with distance sensor for use in indoor plant growing environments according to embodiments. In embodiments, a lighting apparatus 100 may be utilized to provide light to assist in growth of indoor plants. In embodiments, a lighting apparatus 100 may comprising a mounting assembly 105, a light emitting diode (LED) assembly 110 to project light to indoor plants (e.g., may be one or more than one indoor plants), a heat sink 115 coupled to the mounting assembly 105 and coupled to the LED assembly 110, and a mounting plate 117 connected to the heat sink 115 and to the LED assembly 110. In embodiments, a mounting assembly 105 may also be referred to as a hanging assembly 105. In embodiments, a mounting plate 117 may be a plate where a LED assembly 110 may be placed, positioned or mounted on along with other sensor devices. In embodiments, a mounting plate 117 may be reflective to assist in providing light rays or projected light from an LED assembly 110. In embodiments, an LED assembly 110 may be referred to as a lighting assembly 110 because other types of lights may be utilized (e.g., halogen, fluorescent, infrared, etc.) to provide light to indoor plants. In embodiments, a heat sink 115 may be made of a plastic and/or composite material and may have fins in order to dissipate heat.

In embodiments, a power supply 120 may be coupled to a heat sink 115. In embodiments, a power supply 120 may be a switching power supply and may provide sufficient in size to power LED assemblies and/or lighting assemblies 110 of 100 Watts or larger. In embodiments, a power supply 120 may provide voltage and current to generate 100 watts, 150 watts or 200 watts of power to an LED assembly 110 as well as other components in a lighting assembly 100. Other wattage values may also be utilized. In embodiments, a power supply 120 may have an opening in a center to allow a mounting assembly (or handing assembly) 105 to couple to or attach to the heat sink 115. In embodiments, a connector may connect on one end to a mounting assembly or handing assembly 105 and at another end to a heat sink 115. In embodiments, the LED assembly or lighting assembly 110 may be attached and/or adhered to a surface of the mounting plate 117. In embodiments, a power supply 120 may provide power to a LED assembly 110, one or more distance sensors 125 and/or other components of a lighting apparatus 100.

In embodiments, a LED assembly 110 may comprise one LED light on a square integrated circuit. In embodiments, a LED assembly 110 may have a circular shape or a square shape and may be positioned in a center of a surface of a heat sink 115 or mounting assembly 117, as is illustrated in FIG. 1B. FIG. 1B illustrates a bottom view of a lighting apparatus according to embodiments. In embodiments, a LED assembly 110 may be four lines forming a square or a rectangle, as is depicted in FIG. 1D. FIG. 1D illustrates an alternative version of an LED assembly according to embodiments. In embodiments, a LED assembly 110 may generate and project a first color of light (or a first wavelength of light) during a sprout, seedling or vegetative state of an indoor plant (or infancy of an indoor plant), and a second and different color of light during a growth, budding, flowering, and/or ripening state of an indoor plant. In embodiments, a LED assembly 110 may be detachable from a heat sink 115 or mounting assembly 117 to allow for changing of an LED assembly 110 during different periods of growth of an indoor plant, because a higher intensity LED assembly 110 is required and/or replacement of a LED assembly 110 is necessary because a LED assembly 110 is malfunctioning or inoperable. In embodiments, a power supply 120 and/or a mounting assembly or hanging assembly 105 may be located or positioned on a first side or a first surface of a heat sink 115 and a LED assembly 110 and a mounting plate 117 may be located or positioned on a second side or a second surface of a heat sink 115.

In embodiments, a lighting apparatus 100 may further comprise one or more distance sensors 125 (or one or more sensor assemblies). In embodiments, one or more distance sensors 125 may calculate and/or determine a distance from the one or more sensors 125 to one or more indoor plants (e.g., a top portion of indoor plants). In embodiments, one or more distance sensors 125 may generate a distance measurement or distance value, and/or a signal or message representative of a distance measurement or distance value. In embodiments, one or more distance sensors 125 may comprise an ultrasonic sensor and/or a sonic sensor (e.g., the sensor 125 may utilize sound waves to determine a distance). In embodiments, one or more distance sensors 125 may be attached to a mounting plate 117, may be integrated into a mounting plate 117, may be attached to a heat sink 115 and/or integrated into a heat sink 115. In embodiments, one or more distance sensors 125 may be mounted on a first side of a mounting plate 117 which also includes a LED assembly 110. In embodiments, one or more distance sensors 125 may comprise radar sensors, time-of-flight sensors, radiofrequency sensors, infrared sensors, or other light sensors (as long as the light sensors do not pick up the light from the LED assembly 110). In other words, the light sensors may not measure the same spectrum or wavelength of light that is generated by the LED assembly 110). In embodiments, one or more distance sensors 125 may be coupled to a timing device (e.g., a clock or a timer) and may only capture and/or calculate distance measurements once, twice or three times a day. This lowers a power requirement of a lighting apparatus 100 because a distance sensor 125 may only need to be powered on for a short period each day. This is due to the fact that indoor plants do not grow much in a time period of a day and thus a distance measurement may only need to take place one time a day or twice a day. In addition, a distance sensor 125 may be detachable from a lighting apparatus 100 to allow for replacement of a malfunctioning sensor or insertion of a different type of distance sensor. In embodiments, one distance sensor 125 may be shared between more than one lighting apparatus 100 in order to minimize cost in an indoor growing facility. In embodiments, one or more distance sensors 125 may be attached or inserted via an input port of a lighting apparatus 100 which allows the detachability of the one or more distance sensors 125. In embodiments, an input port may provide power for any sensors inserted into or connected to the input port.

FIG. 1D illustrates a block diagram of a lighting apparatus according to embodiments. In embodiments, a lighting apparatus 100 may further comprise a comparison device 130. In embodiments, one or more comparison devices 130 may be coupled to one or more distance sensors 125. In embodiments, a comparison device 130 may be located near a power supply 120 and may receive power from the power supply 120. In embodiments, a comparison device 130 may be located on a mounting plate 117, integrated within a mounting plate 117 and/or be located on a heat sink 115. In embodiments, one or more distance sensors 125 may communicate a captured or generated distance measurement and/or signal representing a generated distance measurement to a comparison device 130. In embodiments, a comparison device 130 may determine if the generated distance measurement and/or signal is smaller than a predetermined distance or predetermined threshold (or larger than an acceptable distance). For example, if an acceptable distance is 5 inches or more between a distance sensor 125 and an indoor plant and a distance sensor determines or calculates a distance value of 4 inches to the indoor plant), the one or more distance sensors 125 may communicate the distance measurement or distance value or 4 inches to the comparison device 130. In embodiments, the comparison device 130 may compare the received distance measurement from the distance sensor 125 and determine if the distance is less than the acceptable distance threshold (which results in a determination that an error condition has occurred and/or a height adjustment may need to be made to a length or height of the mounting assembly 105). In embodiments, the comparison device 130 may generate and communicate an error signal and/or an adjustment signal if the distance measurement is larger than a predetermined distance or threshold. In other words, a comparison device 130 may comprise a memory and may store distance threshold(s) which are considered acceptable, in tolerance or within specified values in one or more memory devices of the comparison device 130. In embodiments, a comparison device 130 may be a comparator, an integrated circuit including comparison circuitry, and/or an ASIC including comparison circuitry. In embodiments, a comparison device 130 may be a processor or controller including one or more memory devices. In embodiments, a processor or controller may referred to as reference number 130.

In embodiments, a lighting apparatus 100 may further comprise an indicator 135 (or indication assembly). In embodiment, an indicator 135 may be a light that is capable of displaying two or more colors (e.g., green for acceptable conditions or red for error or adjustable conditions) or generating different lighting patterns (blinking light versus steady light). In embodiments, an indicator 135 may be a LED display that may display error codes. In embodiments, an indicator 135 may be coupled to a comparison device 130. In embodiments, a comparison device 130 may send an error signal and/or adjustment signal and an indicator 135 may change from a first color (e.g., green identifying light assembly distance to the indoor plant is acceptable) to a second color (e.g., red identifying that the distance to the indoor plant is not acceptable) and that a length and/or a height of a mounting assembly 105 may require adjustment.

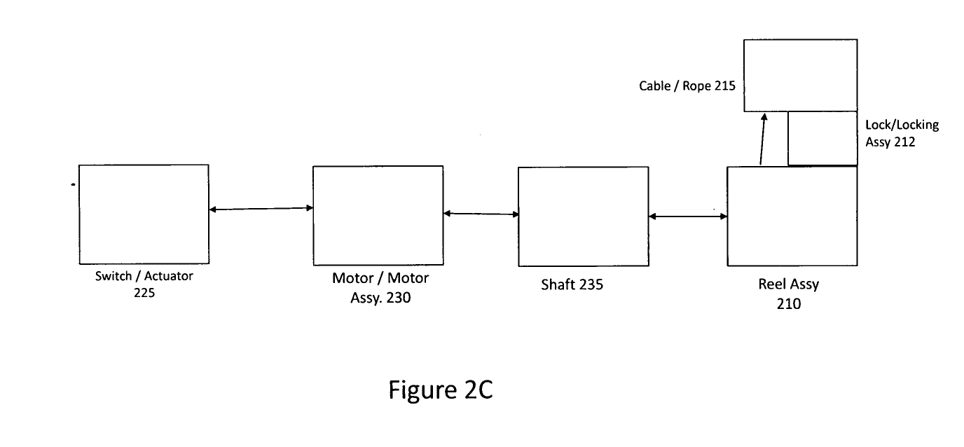

In embodiments, a lighting apparatus 100 may further comprise a distance control assembly or a height adjustment assembly 140. In embodiments, a height adjustment assembly 140 may comprise a knob and a lever that is connected to the mounting assembly or hanging assembly 105. In embodiments, a hanging assembly or mounting assembly 105 may comprise a cable or rope that may be adjusted in height by a pulley assembly. FIGS. 2A and 2B illustrate a hanging assembly or mounting assembly including a reel assembly positioned near a power supply according to embodiments. FIG. 2C illustrates a block diagram of a hanging assembly or mounting assembly according to embodiments. In embodiments, a mounting assembly or hanging assembly 105 may further comprise a distance control knob 205, a lever (not shown), a reel assembly 210, a lock or locking assembly 212 and/or a cable or rope 215. In embodiments, a distance control knob 205 may be connected to a lever. In embodiments, a lever may be connected to a reel assembly 210. In embodiments, a cable or rope 215 may be connected to and/or wind around a reel or reel assembly 210. In embodiments, a locking assembly or lock 212 may be utilized to lock a cable or rope 215 at a certain distance or location. In embodiments, a distance control knob 205 may be moved in a first direction (e.g., an upward or downward direction; or a left or right direction), which causes a lever or lever handle to move. In embodiments, movement of a lever or lever handle results in rotation of a reel or reel assembly 210. In embodiments, a reel or reel assembly 210 may rotate and cause a cable or rope 215 which is wound around it to expand or retract, which in turn causes a length or height of the mounting assembly or hanging assembly to change in distance. In embodiments, once a desired height or distance is reached, a locking mechanism or a lock 212 may be engaged and may lock a cable or rope 215 into a position. In embodiments, a locking assembly or lock may pinch against the rope or cable 215 to prevent movement until a locking assembly or lock 212 is disengaged. FIG. 2B illustrates a mounting assembly comprising a button or switch 225 that may be utilized with a motor or actuator (not shown) to cause movement of a reel or reel assembly 210. In embodiments, a mounting assembly 105 may comprise a button or switch 225, a motor or motor assembly (not shown), a rotating shaft (not shown), a reel or reel assembly 210, a locking assembly or lock 212, and/or a cable or rope 215. In embodiments, a button or switch 225 may be a two-position switch (e.g., on or off) or a three-position switch (up, down, and/or off). In embodiments, an operator and/or user may press, engage and/or toggle a button or switch 225 to move a mounting assembly or hanging assembly 105. In embodiments, a button or switch 225 may be pressed, depressed, toggled and/or engaged which may result in activation of a motor (see FIG. 2C). In embodiments, a motor 230 may turn or rotate a shaft 235. In embodiments, a shaft 235 may rotate and turn a reel or reel assembly 210, which may cause a cable or rope 215 to extend or retract from the reel assembly 210. As discussed before, this may lengthen and/or short the cable or rope 215 and thus adjust a height or length of a mounting assembly or hanging assembly 105 (and thus a distance of a lighting apparatus 100 from the one or more indoor plants. In embodiments, a locking apparatus or lock 212 may be activated and/or engaged to set a position of a cable or rope 215 once the cable or rope gets to the desired position.

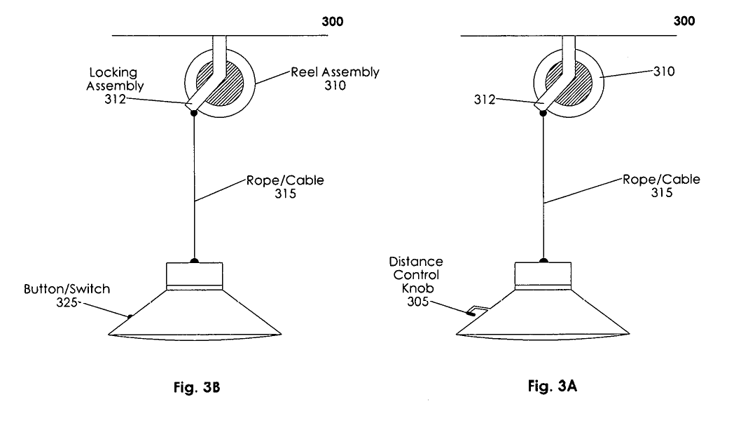

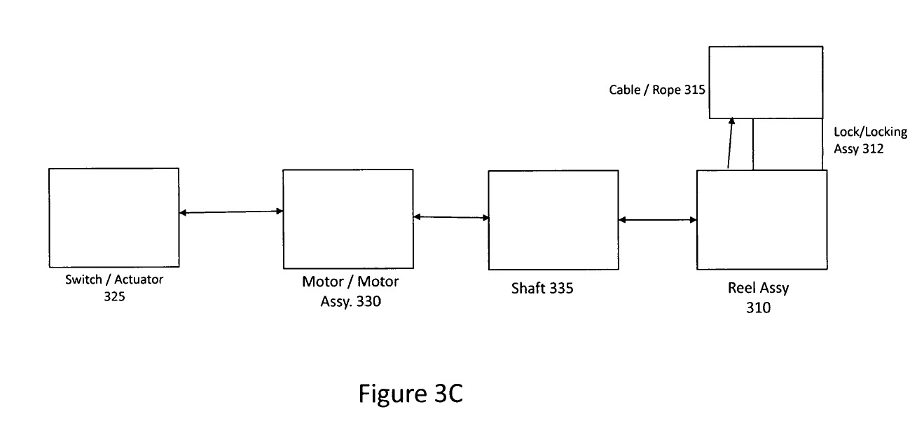

FIGS. 3A and 3B illustrate a lighting apparatus including adjustment occurring closer to a ceiling of an indoor building according to embodiments. In embodiments, a lighting apparatus 300 may further comprise a distance control assembly or a height adjustment assembly 140. In embodiments, a height adjustment assembly 140 may comprise a knob and a lever that is connected to the mounting assembly or hanging assembly 105. In embodiments, a hanging assembly or mounting assembly 105 may comprise a cable or rope that may be adjusted in height by a pulley assembly. FIGS. 3A and 3B illustrate a hanging assembly or mounting assembly including a reel assembly positioned near a ceiling according to embodiments. In embodiments, a mounting assembly or hanging assembly 105 may further comprise a distance control knob 305, a lever (not shown), a reel assembly 310, a lock or locking assembly 312 and/or a cable or rope 315. In embodiments, a distance control knob 305 may be connected and/or mechanically coupled to a lever. In embodiments, a lever may be connected to a reel assembly 310. In embodiments, a reel assembly 310 may be located close to a ceiling as is illustrated in FIGS. 3A and 3B. In embodiments, a cable or rope 315 may be connected to and/or wind itself around a reel or reel assembly 310. In embodiments, a locking assembly or lock 312 may be utilized to lock a cable or rope 315 at a certain distance or location. In embodiments, a distance control knob 305 may be moved in a first direction (e.g., an upward or downward direction; or in a left or a right direction), which causes a lever or lever handle to move. In embodiments, movement of a lever or lever handle results in rotation of a reel or reel assembly 310. In embodiments, a reel or reel assembly 310 may rotate and cause a cable or rope 315 which is wound around it to expand or retract from around the reel assembly 310, which in turn causes a length or height of the mounting assembly or hanging assembly 105 to change in distance. In embodiments, once a desired height or distance is reached, a locking mechanism or a lock 312 may be engaged and may lock a cable or rope 315 into a position. In embodiments, a locking assembly or lock 312 may pinch against the rope or cable 315 to prevent movement until a locking assembly or lock 312 is disengaged. FIG. 3C illustrates a block diagram of a mounting assembly or handing assembly according to embodiments. FIG. 3B illustrates a mounting assembly comprising a button or switch or switching assembly 325 that may be utilized with a motor or actuator (not shown) to cause movement of a reel or reel assembly 310. In embodiments, a mounting assembly 105 may comprise a button or switch 325, a motor or motor assembly (not shown), a rotating shaft (not shown), a reel or reel assembly 310, a locking assembly or lock 312, and/or a cable or rope 315. In embodiments, a button or switch 325 may be a two-position switch (e.g., on or off) or a three-position switch (up, down, and/or off). In embodiments, an operator and/or user may press, engage and/or toggle a button or switch 325 to cause movement of a reel assembly 310 which results in movement (e.g., up or down) of a mounting assembly or hanging assembly 105. In embodiments, a button or switch 325 may be pressed, depressed, toggled and/or engaged which may result in activation of a motor. In embodiments, a motor 330 may turn or rotate a shaft 335. In embodiments, a shaft 335 may rotate and then turn a reel or reel assembly 310 (which is coupled or connected to the rotating shaft 335), which may cause a cable or rope 315 to extend or retract from the reel assembly 310. As discussed before, this may lengthen and/or shorten the cable or rope 315 and thus adjust a height or length of a mounting assembly or hanging assembly 105 (and thus a distance of a lighting apparatus 100 from the one or more indoor plants). In embodiments, a locking apparatus or lock 312 may be activated and/or engaged to set a position of a cable or rope 315 once the cable or rope gets to the desired position.

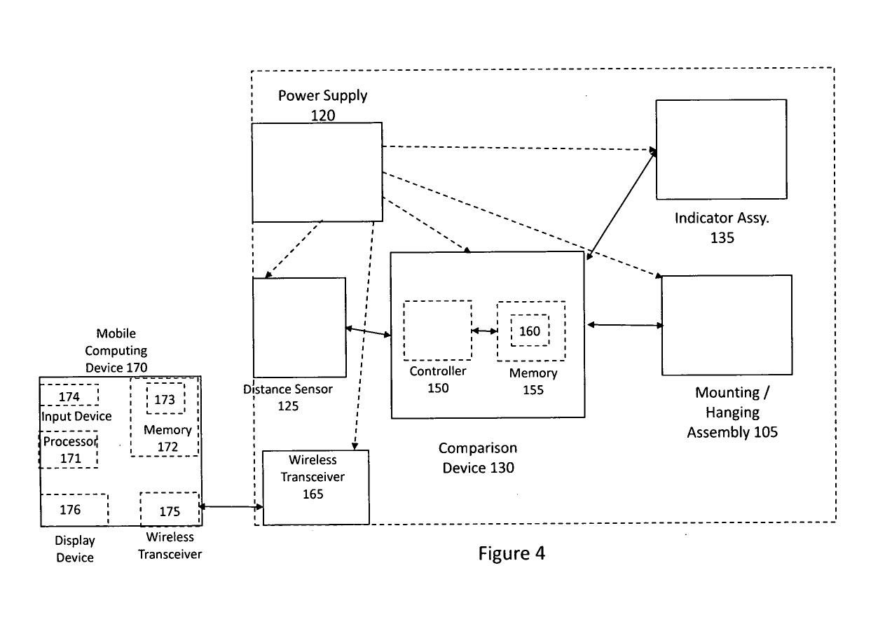

FIG. 4 illustrates an embodiment of a lighting apparatus according to embodiments. In embodiments, a comparison device 130 may comprise one or more controllers and/or processors 150, one or more memory devices 155, and/or computer-readable instructions (software or firmware) 160 loaded into and/or stored in the one or more memory devices. In embodiments, by utilizing one or more controllers and/or processors 150, predetermined distances may be stored in the one or more memory devices 155 and used for comparison purposes with respect to distance measurements and/or distance values captured and/or received from one or more distance sensors 125. In addition, more complex indicators (or indicator assemblies) 135 may be utilized to display error and/or adjustment conditions (e.g., such as alphanumeric displays or LED displays) in order to provide more information to users and operators. For example, in embodiments, a distance sensor or sensor assembly 125 may communicate a distance measurement to a controller or processor 150. In embodiments, computer-readable instructions retrieved from one or memory devices 155 may be executed by one or more processors 150 to retrieve a predetermined distance and/or an acceptable distance threshold from one or more memory devices 155 and compare the retrieved predetermined distance value with the captured distance measurement or distance value from the one or more distance sensors 125. If the captured distance measurement or distance value is less than the predetermined distance threshold, then the computer-readable instructions executed by the one or more processors or controllers 150 may cause an error signal or adjustment signal to be sent to an indicator or indicator assembly 135. In embodiments, the computer-readable instructions 160 executed by the processor or controller 155 may be able to send different types of error signals or adjustment signals to an indicator or indicator assembly 135 (e.g., one error signal may indicate a 1 inch difference between an acceptable distance threshold and a received distance measurement (which results in a slowly blinking light on an indicator 135) and another error signal may indicate a greater than 2 inch difference between an acceptable distance threshold and a received distance measurement (which results in a quickly blinking light on indicator 135)).

In embodiments, a lighting apparatus 100 may further comprise one or more wireless communication transceivers 165. In embodiments, one or more wireless communications transceivers 165 may operate according to personal area network (PAN) protocols, (e.g., a Bluetooth communication protocol, a Zigbee communication protocol, a Z-Wave communication protocol). In embodiments, one or more wireless communication transceivers 165 may operate according to wireless local area network communication protocols such as 802.11 communication protocols and/or WiFi communication protocols. In embodiments, one or more wireless communication transceivers 165 may operate according to cellular communication protocols such as 3G, 4G or 5G. In embodiments, wireless communications transceivers 165 may operate according to DECT and/or ULE protocols, which are low power wireless communication protocols that may be utilized in areas where power consumption and/or power availability are an issue. In embodiments, a lighting apparatus 100 including one or more wireless communication transceivers 165 may communicate with external portable computing devices, personal computing devices, external computing devices, cloud-based computing devices and/or server computing devices.

In embodiments, a mobile computing device 170 may also interface and/or interact with a lighting apparatus 100. FIG. 4 illustrates a computing device (e.g., a mobile computing device) interfacing with a lighting apparatus according to embodiments. In embodiments, a mobile computing device 170 may be a mobile phone, a smart phone, a tablet, a network computing device, a wearable computing device, (e.g., a watch computing device and/or spectacle computing devices). In embodiments, a mobile computing device 170 may comprise one or more processors 171, one or more memory devices 172, computer-readable instructions 173 stored in the one or more memory devices (e.g., software applications, device drivers, operating system, etc.), one or more input devices 174 (e.g., touch screen, keypad, stylus, keyboard, etc), and/or one or more wireless transceivers 175. In embodiments, computer-readable instructions 173 executable by one or more processors 171 may be developed for interfacing and/or controlling one or more lighting apparatuses 100. In other words, a lighting assembly software application may be resident on mobile computing device 170. In embodiments, a computer-readable instructions 173 executable by one or more processors 171 may communicate with one or more lighting apparatus 100 via a wireless communications transceiver 175. In embodiments, the wireless communications transceiver 175 of the mobile computing device 170 may operate according to PAN communication protocols (Bluetooth), LAN communication protocols (e.g., 802.11 or WiFi) and/or cellular communication protocols (e.g., 3G, 4G, and/or 5G). In embodiments, a wireless transceiver 175 in a mobile computing device 170 may communicate with a wireless transceiver 165 in a lighting apparatus 100 to interface with and interact with one or more lighting assemblies.

In embodiments, computer-readable instructions 173 executable by one or more processors 171 on a mobile computing device 170 may communicate commands, instructions or messages via wireless transceiver 175 to a wireless transceiver 165 in a lighting apparatus 100 to initiate operation of a distance sensor 125, which calculates and/or captures a distance between a distance sensor 125 and one or more indoor plants. In embodiments, messages may be received at one or controllers or processors 150 in a lighting apparatus and computer-readable instructions executed by the one or more processors 150 in a lighting apparatus 100 may communicate a signal and/or command to a distance sensor 125 to capture or calculate a distance measurement to the one or more plants. In embodiments, a distance sensor 125 may communicate a captured or calculated distance measurement to a processor and/or controller 150 and computer-readable instructions may be executed by a processor and/or controller to communicate the captured distance measurement to the portable computing device 175 via the lighting apparatus wireless transceiver 165 and the mobile computing device wireless transceiver 175. In embodiments, computer-readable instructions 173 executed by the one or more processors 171 of the mobile computing device may compare a received captured distance measurement and a preexisting and/or predetermined distance threshold to determine if a mounting assembly 105 height or length should be adjusted. In the received distance is less than the predetermined distance threshold, then computer-readable instructions 173 executed by a processor 171 on the mobile device 170 may communicate a message to a display device 176 of the mobile computing device indicating an error condition has occurred and that a height adjustment may need to be made. In embodiments, computer-readable instructions 173 executed by a processor 171 of the mobile computing device 170 may communicate a message to a sound reproduction device (e.g., speaker) 177 of the mobile computing device to audibly alert a user or operator of an error condition which may require a height or length adjustment of a mounting assembly 105. In embodiments, computer-readable instructions 173 executable by one or more processors 171 on a mobile computing device 170 may communicate a command, message and/or instruction to a processor or controller 150 on a lighting apparatus 100 to change a state or status of an indicator (or indicator assembly) 135 (via the wireless transceivers 175 (mobile computing device) and 165 (lighting assembly)). In embodiments, computer-readable instructions executable by a processor/controller 150 of a lighting apparatus 100 may communicate a message, command, instruction or signal to an indicator or indicator assembly 135 to change status to an error or adjustment condition (e.g., change from a green light to a red light). Above, an example is discussed where a distance measurement is less than a predetermined threshold. However, everything discussed herein could be applied to situations where a distance measurement is greater than a predetermined threshold, which creates an unacceptable growing climate, and thus a lighting apparatus may need to be adjusted to be closer to one or more indoor plants.

In embodiments, utilizing a mobile computing device 170 with a software application (e.g., computer-readable instructions executable by one or more processors of the mobile computing device) to communicate with a lighting apparatus provides many benefits and/or advantages over an existing lighting apparatus. An operator and/or user may set one or more predetermined thresholds for acceptable distance values between a distance sensor 125 and one or more indoor plants. For example, as a plant goes into different stages of growth, different distances may be needed between the LED assembly 110 and the indoor plant in order to maximize growth. Accordingly, the capability of having multiple threshold distances stored in a memory of a mobile computing device 175 is a benefit so that the distance thresholds may match and/or align with different growth stages of indoor plants. For example, in embodiments, during infancy of the indoor plant, the LED assembly 110 should be 3 inches or more away from the plant (it is not preferable to closer than 3 inches). However, during growth stages of the plant, the LED assembly 110 should be 4.5 inches or more from the indoor plants. In embodiments, these different threshold measurements may be stored in one or more memory devices 172 of the mobile computing device 170 and may be changed and/or selected as indoor plants reach different growth stages. In embodiments, depending on growth stage, different thresholds may be retrieved or accessed from the one or more memory devices 172 in the mobile computing device 170.

Another advantage of utilizing a mobile computing device 170 with a lighting apparatus may be that a mobile computing device 170 may communicate with multiple (or more than one) lighting apparatuses 100. In embodiments, indoor plant growing environments may be one room, multiple rooms, one floor and/or an entire warehouse of indoor plants. It would be very difficult to manage a plurality of the lighting apparatuses needed in a large indoor environment without utilizing a mobile computing device 170. In embodiments, a single mobile computing device 170 may communicate with two or four lighting apparatuses simultaneously (or a larger number). In embodiments, computer-readable instructions 173 executable by one or more processors 171 may communicate with each of the lighting apparatuses 100 simultaneously to instruct distance sensors 125 on each of the lighting apparatuses 100 to be activated and initiate capturing of distance measurements. This allow easy initiation of measuring distances between a number of distance sensors 125 in a corresponding plurality of lighting assemblies and a corresponding plurality of indoor plants. In embodiments, for example, distance sensors 125 may communicate captured distance measurements or distance values to controllers or processors 130/150 in a lighting apparatus 100, which may communicate the plurality of captured distance measurements to the mobile computing device 170 via wireless transceivers 165 (lighting assembly transceiver) and 175 (mobile computing device transceiver). In embodiments, separate windows may be presented and/or displayed on a screen or display of a mobile computing device 170 for each of the captured distance measurements and corresponding lighting assemblies. In embodiments, for example, computer-readable instructions 173 executable by one or more processors 171 may receive captured sensor measurements from corresponding distance sensors 125 in associated lighting apparatuses 100. In embodiments, computer-readable instructions 173 executable by one or more processors 171 of the mobile computing device 170 may compare stored distance thresholds for each of the lighting apparatuses 100 against the received captured distance measurements or distance values to determine which of the lighting apparatuses may be too close to the respective plants (or too far away). In embodiments, computer-readable instructions 173 executable by one or more processors 171, may, after the determination is made, communicate an error condition and/or adjustment signals to the respective lighting apparatuses (e.g., indicator assemblies) to identify that adjustments to a length or height of a mounting assembly 105 should be made and/or that a state of an indicator or indicator assembly 135 should be changed. In embodiments, for example, computer-readable instructions 173 executable by one or more processors 171 may communicate error messages/signals and/or adjustment messages to two of four lighting apparatuses 100 while the other two of four lighting apparatuses 100 do not receive communications at all from the mobile computing device 175 because the sensor assembly 125 in the corresponding lighting apparatus 100 is within an acceptable distance of the indoor plants. In embodiments, computer-readable instructions 173 executable by one or more processors 171 may communicate messages to a display or screen of a mobile computing device 170 to display which of the lighting apparatuses 100 may need adjustments in a height or length of a respective mounting assembly 105. In embodiments, computer-readable instructions 173 executable by one or more processors 171 may communicate signals and/or audio files to a sound reproduction device of a mobile computing device 170 to identify which if any of lighting apparatuses 100 should have adjustments made in a height or length of an associated mounting assembly 105. In embodiments, a mobile computing device 170 (e.g., software on the mobile computing device) may communicate with different lighting apparatus 100 at different times depending upon requirements of an indoor growing facility (e.g., may initiate activation of distance sensors 125 for associated lighting assemblies 100 at different times). Although simultaneous communication is discussed above, a mobile computing device may communicate with one or more lighting apparatuses 100 separately (e.g., by separate user or operator-initiated communications) and/or in a timed or sequenced interval fashion.

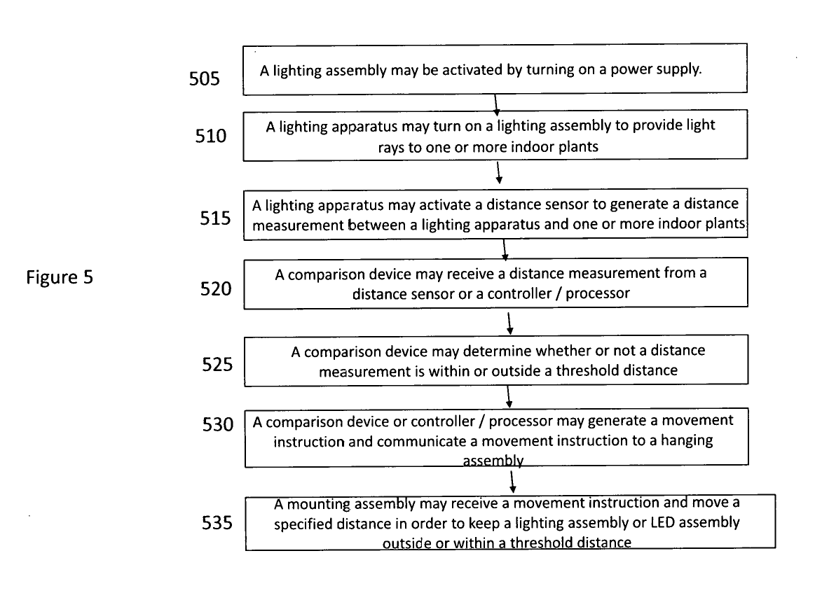

FIG. 5 illustrates a flowchart of a lighting apparatus operation according to embodiments. In embodiments, a lighting assembly may be activated 505 by turning on or activating a power supply. In embodiments, a timer may be utilized to activate a power supply. In embodiments, a lighting apparatus may turn on 510 a lighting assembly to provide light rays to one or more indoor plants. In embodiments, a lighting apparatus may activate 515 a distance sensor to generate or capture a distance measurement between a lighting apparatus (e.g., lighting assembly) and one or more indoor plants. In embodiments, a comparison device may receive 520 a distance measurement from a distance sensor and/or a controller/processor. In embodiments, a comparison device may determine 525 whether or not a distance measurement is within or outside a threshold distance. In embodiments, if a distance measurement is smaller than a threshold distance, a comparison device or controller/processor may generate a movement instruction or command and communicate 530 a movement instruction or command to a hanging assembly or mounting assembly. In embodiments, a comparison device may generate a movement instruction if a distance measurement is greater than a threshold distance or if a distance measurement is less than a threshold distance. In embodiments, a mounting assembly or hanging assembly may receive a movement instruction and may move 535 a specified distance in order to keep a lighting assembly or LED assembly outside or within a threshold distance.

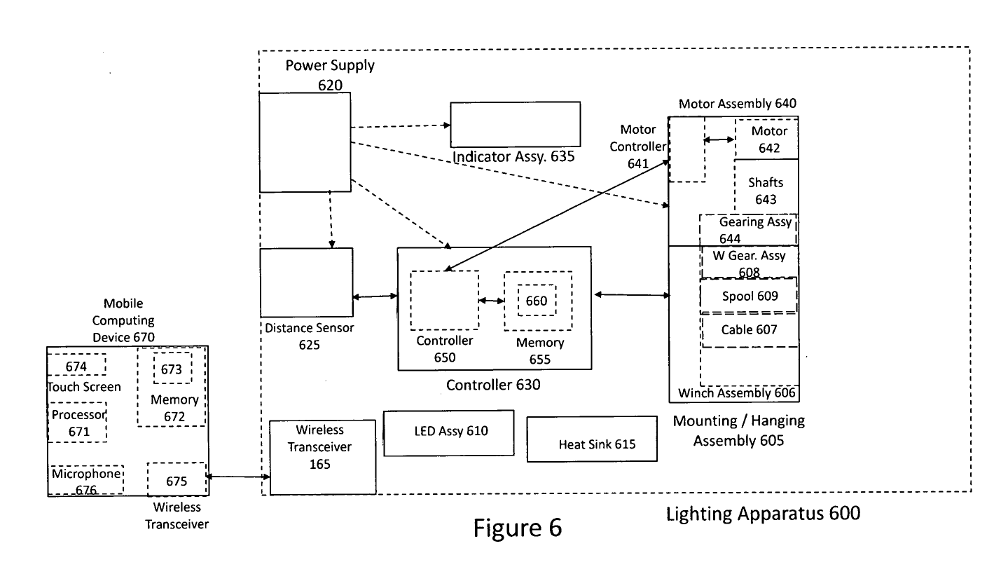

In embodiments, a lighting apparatus 600 may have devices allowing automatic operation and/or adjustment of a height or length of a mounting assembly 605. FIG. 6 illustrates a block diagram of automatic adjustment devices in a lighting apparatus including an adjustment assembly or winching assembly according to embodiments. In embodiments, a lighting apparatus 600 may comprise a mounting assembly 605, a LED or light assembly 610, a heat sink 615, a power supply 620, one or more distance sensors 625, one or more controllers (or comparison devices) 630, one or more indicators or indicator assemblies 635 and one or more motor assemblies 640. In embodiments, the one or more motor assemblies 640 may communicate with and mechanically interface with a mounting assembly 605 to adjust a height and/or length of a mounting assembly 605. In embodiments, a motor assembly 640 may comprise a motor controller 641, a motor 642, a rotating shaft 643 and/or one or more gearing assemblies 644. In embodiments, a mounting assembly 605 may comprise a winch assembly 606. In embodiments, a gearing assembly 644 in a motor assembly 640 may be connected and/or coupled to a winch assembly 606, where the winch assembly 606 extends and/or retracts a rope and/or cable 607 to lengthen or shorten a height or length of a mounting assembly 605. In embodiments, a winch assembly 606 may comprise one or more gearing assemblies 608, which may engage gearing assemblies of motor assembly 640. In embodiments, the winch assembly 606 gearing assemblies 608 may drive or cause a spool or reel 609 to rotate, which may cause a rope or cable 607 to expand or retract from its position around a spool or reel 609.

In embodiments, a motor controller 641 may receive a signal instructing that a motor 642 may be engaged or activated to rotate a shaft 643 in a first direction (or in a second opposite direction). In embodiments, as a shaft 643 rotates, gearing assemblies 644 may rotate, which engages gearing assemblies 608 in a winch assembly 606 to rotate. In embodiments, the rotation of gearing assemblies 608 in a winch assembly 606 may cause a spool 609 to rotate. In embodiments, rotation of a spool 609 may cause a cable or rope 607 to extend or retract. In other words, a rope or cable 607 may be lengthened or shortened to increase (or decrease) a height or length of a mounting assembly 605. In embodiments, a switch (e.g., a transistor (or other electronic switch), a mechanical switch and/or an electromechanical switch) may be utilized to activate (e.g., communicate or pass a signal to) a motor controller 641. In embodiments, a switch may be positioned on a power supply 620 or a heat sink 615 and may be coupled to a motor controller 641 and/or a controller 630.

In embodiments, a controller 630 in a lighting apparatus 600 may control operation of a motor assembly 640 and/or a winch assembly 606. In embodiments, computer-readable instructions stored in one or more memory devices may be executed by a controller 630 to control operation and/or initiation of a motor assembly 640. In embodiments, a distance sensor 625 may communicate a distance measurement or a distance value to a controller 630. In embodiments, a controller or processor 630 may analyze the distance value or distance measurement to determine if a mounting assembly or a hanging assembly 605 needs to be moved and/or adjusted. If a mounting assembly or hanging assembly 605 needs adjustment in length or height, computer-readable instructions stored in one or more memory devices may be executed by a controller 630 to communicate adjustment signals, messages and/or instructions to a motor assembly 640 to cause the motor assembly 640 to be activated and thus rotate, which causes the winch assembly 606 (e.g., gearing assemblies 608 and the spool 609) to rotate and thus extend and/or retract a rope and/or cable 607. In embodiments, a controller 630 may be advantageous over manual operation (e.g., a switch) in that a controller 630 may provide more accurate adjustment signals, messages and/or instructions in order to move the mounting assembly 605 a set distance, rather than the hit or miss (trial or error) of manual operation by manual turning on and off of the switch.

In embodiments, a mobile computing device 670 may control operation of a motor assembly 640 and thus a winch assembly 606 in a lighting apparatus 600. In embodiments, a mobile computing device 670 may comprise one or more processors 671, one or more memory devices 672, computer-readable instructions 673 (e.g., a software application) and/or one or more wireless communications transceivers 675. In embodiments, after receipt of distance measurements and/or distance values from a lighting apparatus 600, one or more processors 671 may analyze the distance measurements and/or distance values and determine if adjustment of a height and/or length of a lighting apparatus 600 should be made or requested. If the computer-readable instructions 673 executable by one or one or more processors 671 determine that a mounting assembly 605 should be adjusted, computer-readable instructions 673 executable by one or more processors 671 may instruct the one or more processors 671 to generate adjustment messages, instructions and/or commands and communicate the adjustment message, instructions and/or commands to a motor assembly 640 in the lighting assembly (via wireless transceivers 675—mobile computing device and 665—lighting assembly). In embodiments, the one or more adjustment messages, instructions and/or commands may first be communicated to a lighting assembly controller 630 before the motor assembly 640. In embodiment, the one or more adjustment messages, commands and/or instructions may cause motor assembly 640 to be activated and rotate, which causes the winch assembly 606 (e.g., the spool 309) to rotate and thus extend and/or retract a rope and/or cable 607. In embodiments, as discussed previously, mobile computing device control of motor assemblies may be advantageous over manual operation (e.g., a switch) or light assembly controller in that a mobile computing device 670 may be able to control one or more lighting apparatuses as well as to have adjustable thresholds for comparison to determine if adjustment signals are to be generated and/or communicated to the lighting apparatus. In addition, a mobile computing device 670 does not necessarily have to be in a same facility as the indoor plants, the mobile computing device 670 just needs to be able to establish wireless communications with the one or more lighting apparatuses 600.

In embodiments, a mobile computing device 670 software application (e.g., computer-readable instructions 673 executable by one or more processors 671) may allow touch screen adjustment and/or voice-control adjustment of mounting assemblies 605 of one or more lighting apparatuses 600. In embodiments, a user and/or operator may communicate voice commands and one or more microphones 676 in a mobile computing device 670 may capture voice commands and convert the voice commands to audio files. In embodiments, the computer-readable instructions 673 executable by the one or more processors 671 may convert the audio files to command instructions, messages and/or commands and may cause the one or more processors 671 of the mobile computing device 670 to generate and communicate adjustment messages, commands and/or instructions (based at least in part on the received voice commands) to one or more lighting apparatuses 600 which results in mounting assemblies or hanging assemblies 605 being adjusted in height or length, based at least in part on the received voice commands. In embodiments, a mobile device 670 software application may generate an animation (e.g., image) of one or more lighting apparatuses on a display of a mobile computing device 670. In embodiments, a user or operator may touch a screen to provide a requested adjustment of one or more lighting apparatuses 600. In embodiments, computer-readable instructions 673 executable by one or more processors 671 may receive the touch screen input 674 and convert the input to representative messages, instructions or commands based at least in part of detected distance of touch screen 674 input. In embodiments, computer-readable instructions 673 executable by one or more processors 671 may receive the representative messages, instructions or commands and cause the one or more processors 671 to generate and communicate adjustment messages, commands or instructions to one or more lighting apparatuses 600 via the wireless transceivers 675 (mobile computing device) and 665 (lighting apparatus). In embodiments, the lighting apparatus 600 may receive the communicated adjustment messages, commands or instructions and adjust the mounting assemblies 605, based at least in part on the touch screen input, using techniques discussed previously.

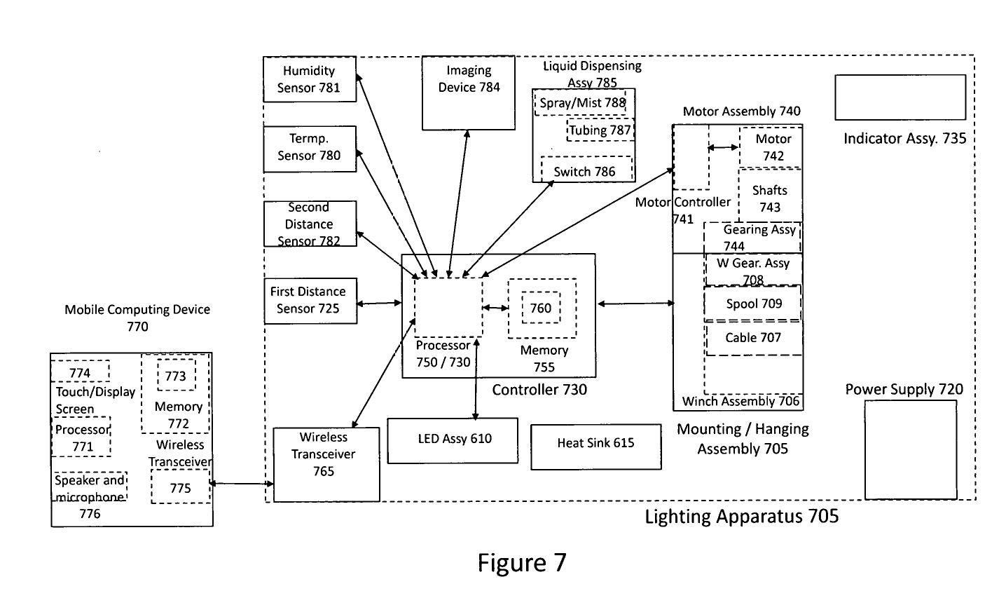

FIG. 7 illustrates a lighting apparatus comprising additional sensors, a spraying apparatus or one or more imaging devices according to embodiments. In embodiments, a lighting apparatus 700 may comprise additional sensors (e.g., one or more temperature sensors 780, one or more humidity sensors 781, one or more second distance sensors 782 to measure distance to a ceiling of an indoor facility), a liquid misting or spraying apparatus 783 and one or more imaging devices 784 to assist in providing a positive growing experience for the one or more plants in the indoor facility. FIG. 7 illustrates a block diagram of automatic adjusting assemblies described above in a lighting apparatus according to embodiments. In embodiments, a lighting apparatus 700 may comprise a mounting assembly or handing assembly 705, a LED or light assembly 710, a heat sink 715, a power supply 720, one or more first distance sensors 725, one or more controllers or processors 730, one or more indicators or indicator assembly 735, one or more wireless communication transceivers 765 and one or more motor assemblies 740.

In embodiments, a lighting apparatus 700 may further comprise one or more second distance sensors 782 to measure a distance from the one or more distance sensors to a ceiling of a room or facilities to which the mounting assembly 705 of the lighting apparatus 700 is attached. In embodiments, one or more second distance sensors 782 may be mounted on a surface of a lighting apparatus 700 opposite of a surface where the LED assembly 710 or one or more first distance sensors 725 are resident or placed. In embodiments, one or more second distance sensors 782 may be sonic sensors, ultrasonic sensors, radar sensors, radiofrequency sensors, and/or light sensors. In embodiments, one or more second distances sensors 782 may capture a second distance measurement or distance value from the light apparatus 700 to a ceiling of an indoor facility or a room. In embodiments, this may be advantageous because the captured second measurement identifies or places a limit on a distance or height that a lighting apparatus 700 may be adjusted. In embodiments, for example, a comparison device, a controller or processor 730 or computer-readable instructions executable by the one or more controllers or processors (whether on the lighting assembly 700 or the mobile computing device 770) may determine that a mounting assembly 705 (e.g., a winching assembly 706 including a rope or cable 707) should have an adjustment of 3 inches in order to maintain an acceptable distance between the LED assembly or lighting assembly 710 and the one or more plants. However, a lighting apparatus 700 may not be able to be within 5 inches of a ceiling of an indoor facility or room due to heat dissipation issues, mounting assembly physical issues (e.g., winch assembly may be physically too big), and/or component operational issues (e.g., wireless transceivers or sensors may not operate properly when so close to a ceiling). According, one or more second distance sensors 782 may work in conjunction or combination with computer-readable instructions executable by one or more processors to limit an upward adjustment of a mounting assembly or hanging assembly 705. In embodiments, for example, computer-readable instructions executable by one or more processors (e.g., in a lighting apparatus 700 or a mobile computing device 770) may communicate a command, instruction or signal to one or more second distance sensors 782 to determine how far the one or more second distances sensors 782 are from a ceiling of an indoor facility or room. In embodiments, the one or more second distance sensors 782 may capture a second distance measurement or distance value and communicate the second distance measurement of value to the controller or processor 730. In embodiments, computer-readable instructions 732 executable by one or more processors 731 may compare the received second distance to the ceiling with the requested adjustment distance and determine how far (e.g., a revised adjustment distance) a mounting assembly or hanging assembly 705 may be moved or adjusted based on the received information. In the example above, if the one or more second distance sensors 782 captures that the second distance value or distance measurement (e.g., to the ceiling) is 7 inches, the requested adjustment is 3 inches and the mounting assembly cannot be closer than 5 inches to the ceiling), then the computer-readable instructions 732 executable by one or more processors 731 may generate or calculate a revised adjustment distance or revised adjustment value. In embodiments, the computer-readable instructions 732 executable by the one or more processors 731 may communicate commands, instructions, messages or signals to the motor assembly 740 to move and/or adjust the hanging assembly or mounting assembly 705 the revised adjustment distance. In the example described above, the revised adjustment distance or revised adjustment value may be 2 inches (e.g., requested distance was 3 inches but the mounting assembly may only move 2 because it is 7 inches to the ceiling minus the 5 inches that the lighting apparatus 700 must remain from the ceiling). In embodiments, a mobile computing device 770 may also control initiation or utilization of the one or more second distance sensors 782 to prevent conditions in which a lighting apparatus 700 may be placed in an unsafe condition by being moved too close to a ceiling of an indoor facility or room.

In embodiments, one or more temperature sensors 780 may measure a temperature of an environment surrounding one or more indoor plants. In embodiments, this may provide vital information as to whether a temperature in an indoor growing environment is within an acceptable range and whether any adjustments in a lighting apparatus 700 may be necessary based at least in part on the captured temperature reading. In embodiments, if a temperature reading is too high, a LED assembly or lighting assembly 710 may need to turned-off, deactivated and/or lowered in intensity to reduce a temperature in an environment surrounding the indoor plant to an acceptable level. In embodiments, if a temperature reading is too high, a message may need to be communicated to a mobile computing device 700 or external computing devices identifying that an abnormal or potentially dangerous situation is present. In embodiments, computer-readable instructions executable by one or more processors (e.g., 730 or controller 730) in a lighting apparatus 700 may periodically request activation of a temperature sensor 780 (e.g., every hour, half-a-day, daily and/or weekly) to monitor temperature in an indoor environment. In embodiments, one or more temperature sensors 780 may capture a temperature measurement and communicate a temperature measurement or temperature value to one or more processors 730 in a lighting apparatus 700 (or one or more processors in a mobile computing device 770). In embodiments, computer-readable instructions 760 executable by one or more processors 730/750 may retrieve an acceptable temperature range (e.g., for growing plants) from one or more memory devices 755 and may compare a received temperature measurement or temperature value to determine if the received temperature measurement is outside an acceptable temperature range. In embodiments, computer-readable instructions 760 executable by the one or more processors 730/750 may generate a message, command or instruction to one or more LED assemblies or lighting assemblies 710 to deactivate and/or lower an intensity of the LED assemblies or lighting assemblies 710. In embodiments, computer-readable instructions 760 executable by one or more processors 730/750 may also generate a message, instruction and/or command to be sent to a mobile computing device 770 to identify that a measured temperature is outside an acceptable range. In embodiments, a mobile computing device 770 may display such message on a display device 774 and/or generate a sound to be replayed on a sound reproduction device 776 to identify that the temperature is outside the acceptable range. The temperature may be monitored and once an acceptable temperature is present one or more lighting assemblies 710 may be activated utilizing techniques described above.

In embodiments, one or more humidity sensors 781 may measure a humidity of an environment surrounding one or more indoor plants. In embodiments, a humidity sensor 781 may provide vital information as to whether a humidity in an indoor growing environment is within an acceptable range and whether any adjustments in a lighting apparatus 700 may be necessary based at least in part on the captured humidity reading or humidity measurement. In embodiments, if a humidity reading is too high, a LED assembly or lighting assembly 710 may need to turned-off, deactivated and/or lowered in intensity to reduce humidity in an environment surrounding the indoor plant to an acceptable level. In embodiments, if a humidity reading is too high, a message may need to be communicated to a mobile computing device 770 or external computing devices identifying that an abnormal or potentially dangerous situation is present and that growth on indoor plants may be impacted. In embodiments, computer-readable instructions 760 executable by one or more processors 730/750 in a lighting apparatus 700 may periodically request activation of a humidity sensor 781 (e.g., every hour, half-a-day, daily and/or weekly) to monitor humidity in an indoor environment. In embodiments, one or more humidity sensors 781 may capture a humidity measurement and communicate a humidity measurement or humidity value to one or more processors 730/750 in a lighting apparatus 700 (or one or more processors in a mobile computing device 770). In embodiments, computer-readable instructions 760 executable by one or more processors 730/750 may retrieve an acceptable humidity range (e.g., for growing plants) from one or more memory devices 755 and may compare a received humidity measurement or humidity value to determine if the received humidity measurement is outside the acceptable humidity range. In embodiments, computer-readable instructions 760 executable by the one or more processors 730/750 may generate a message, command or instruction to one or more LED assemblies or lighting assemblies 710 to deactivate and/or lower an intensity of the LED assemblies or lighting assemblies 710 in order to attempt to reduce humidity. In embodiments, computer-readable instructions 760 executable by one or more processors 730/750 may also generate a message, instruction and/or command to be sent to a mobile computing device 770 to identify that a measured humidity is outside an acceptable range. In embodiments, a mobile computing device 770 may display such message or generate a sound to identify that the humidity is outside the acceptable range.

In embodiments, one or more humidity sensors 781 and/or one or more temperature sensors 780 may need to be placed on a portion of a lighting apparatus 700 away from the LED assembly or lighting assembly 710 in order to prevent an intensity of light emitted (and/or resulting heat) from the LED assembly or lighting assembly 710 from interfering with readings or measurements (and operation) of one or more temperature sensors 780 and/or one or more humidity sensors 781 (these sensors may be placed an outer edges of a lighting apparatus or on a surface opposite to a surface that includes the LED assembly or lighting assembly 710. In embodiments, one or more temperature sensors 780 and/or humidity sensors 781 may be detachable from a lighting apparatus 700 in order to utilize the temperature sensors 780 or humidity sensors 781 with multiple lighting apparatuses. In embodiments, one or more humidity sensors 781 or one or more temperature sensors 780 may be downward facing or sideways facing from a lighting apparatus 700 to obtain a temperature measurement and/or humidity measurement from an area closer to and/or more representative of the temperature around the plants.

In embodiments, if a temperature measurement and/or humidity measurement is too high in an indoor environment, it may be preferable to dispense liquid in an environment to assist in reducing a temperature or humidity in the indoor environment surrounding the plants. In embodiments, a lighting apparatus 700 may further comprising a liquid dispensing assembly 785. In embodiments, a liquid dispensing assembly 785 may comprise a controller or switch 786, tubing 787 and/or a spraying or misting device 788. In embodiments, computer-readable instructions 760 executable by one or more processors 730/750 may analyze received temperature measurements and/or humidity measurements and determine is a liquid may need to be sprayed and/or misted into the environment surrounding indoor plants. In embodiments, if a determination is made identifying that liquid needs to be sprayed or misted, computer-readable instructions 760 executed by one or more processors 730/750 may instruct and/or command one or more processors or controllers 730 to communicate a dispensing instruction, command and/or message to a controller or switch 786 of a liquid dispensing assembly 785 to initiate operation. In embodiments, if the switch 786 is activated, a valve may be opened to allow liquid from a facility reservoir and/or facility tubing to be dispensed into tubing 787 and further to the spraying or misting device 788. In embodiments, the spraying or misting device 788 may dispense (e.g., spray or mist) the dispensed liquid into an environment surrounding the indoor plants. In embodiments, operation (e.g., spraying or misting) may occur for a period of time and/or until instructions or commands are received from a controller or processor 730 to stop spraying or misting.

In embodiments, a lighting assembly 700 may comprise one or more imaging assemblies 784 to capture images around a lighting assembly. In embodiments, one or more imaging assemblies 784 may allow for monitoring of indoor plants in real time (which may allow users and/or operators to see if objects, individuals and/or animals are present in an environment). In embodiments, one or more imaging assemblies 784 may capture images and a lighting assembly (or mobile computing device) may analyze the image to determine health of one or more plants in an indoor environment. For example, a captured image may be analyzed to determine if a plant is wilting, growing sideways, and/or has disease present on one or more leaves and/or branches. In embodiments, one or more imaging assemblies 784 may capture a heat profile of one or more of the indoor plants to determine if plants are growing properly based on a heat profile or if any diseases or other issues are visually present on one or more indoor plants. In embodiments, one or more imaging devices 784 may be infrared cameras, one or more thermal imaging cameras, one or more CCD cameras, one or more video cameras, one or more HD cameras, one or more infrared cameras and/or one or more laser scanners to create a profile.

In embodiments, computer-readable instructions 760 executable by one or more processors 730/750 in a lighting apparatus 700 may periodically request activation of one or more imaging devices 784 (e.g., every hour, half-a-day, daily and/or weekly) to capture images in an indoor environment. In embodiments, computer-readable instructions 760 executable by one or more processors 730/750 may activate one or more imaging devices 784 for a period of time (e.g., 30 minutes, an hour and/or two hours) for real-time monitoring of an indoor environment. In embodiments, one or more imaging devices 784 may capture video, images, audio, and/or thermal heat profiles (from heat sensing or infrared cameras which may be referred to as heat radiation images) of an environment surrounding the plant and communicate the captured video, images, audio, and/or thermal heat profiles to one or more processors 730/750 in a lighting apparatus 700. In embodiments, computer-readable instructions 760 executable by one or more processors 730/750 may store captured video, images, audio and/or thermal heat profiles in one or more memory devices 755 of the lighting apparatus 700. In embodiments, analysis of images, video, audio and/or thermal heat profiles may be performed utilizing computer-readable instructions 760 executable by one or more processors 730/750 but the following description involves communicating and/or transferring video, images, audio and/or thermal heat profiles to a mobile computing device 770, remote computing devices, and/or other servers. In embodiments, computer-readable instructions 760 executable by one or more processors 730/750 may communicate captured image files, video files, audio files and/or thermal heat profiles files to a mobile computing device 770 via a wireless transceiver 765 in a lighting apparatus to a wireless transceiver 775 in a mobile computing device 770. In embodiments, computer-readable instructions 773 executable by the one or more processors 771 in a mobile computing device 770 may store received image files, video files, audio files and/or thermal heat profile files in one or more memory devices 772 of a mobile computing device 770 for later analysis. In embodiments, computer-readable instructions 773 executable by one or more processors 771 may communicate the received image files, video files and/or thermal heat profile files to a display or screen 774 of a mobile computing device 770 for review by a user or operator (such as for use in real-time monitoring, real-time analysis of plant growth, plant stature and/or plant health, or viewing of a heat profile of an indoor plant). In embodiments, computer-readable instructions 773 executable by one or more processors 771 may communicate sound files to a sound reproduction device 776 for playback with or without video file playback. In embodiments, computer-readable instructions 773 executable by one or more processors 771 may analyze the captured and received image files, video files, and/or thermal heat profiles to determine plant growth, plant stature, and/or plant health. In embodiments, computer-readable instructions 773 executable by one or more processors 771 may analyze the captured and received images, videos and/or thermal heat profiles to determine if a thermal heat profile, plant mage or plant video is acceptable or if an error condition and/or dangerous condition is present. In embodiments, these computer-readable instructions may be image processing software (or video processing software or thermal heat processing software) that identifies plant structures and compares plant structures and geometries and color to determine whether plant if properly growing, has the right structure and/or is healthy or has diseased leaves. In embodiments, computer-readable instructions executable by one or more processors may also generate a message, instruction and/or command to be sent to a mobile computing device 770 to communicate conditions identified by the image processing software, video processing software or thermal heat profile processing software. In embodiments, a mobile computing device 770 may display such message or generate a sound to identify the communicated conditions identified by the image processing software, video processing software or thermal heat profile processing software.

In embodiments, an imaging device 784 may comprise a 3D laser scanner, which may be utilized in conjunction with a vision inspection apparatus or software to create one or more two-dimensional or three-dimensional images of one or more indoor plants. In embodiments, computer-readable instructions 760 executable by one or more processors 730/750 in a lighting apparatus 700 may periodically request activation of one or more imaging devices (e.g., 3D laser scanner) 784 (e.g., every hour, half-a-day, daily and/or weekly) to capture one or more two-dimensional or three-dimensional images in an indoor environment. In embodiments, computer-readable instructions 760 executable by one or more processors 730/750 may activate one or more imaging devices (e.g., 3D laser scanner) 784 for a period of time (e.g., 30 minutes, an hour and/or two hours) for real-time monitoring of an indoor environment. In embodiments, one or more imaging devices (e.g., 3D laser scanner) 784 may capture two-dimensional or three dimensional images (from a 3D laser scanner) of an environment surrounding the plant and communicate the captured two dimensional or three dimensional images to one or more processors 730/750 in a lighting apparatus 700. In embodiments, computer-readable instructions 760 executable by one or more processors 730/750 may store captured two dimensional or three dimensional images in one or more memory devices 755 of the lighting apparatus 700. In embodiments, analysis of two dimensional or three dimensional images may be performed utilizing computer-readable instructions 760 executable by one or more processors 730/750, but the following description involves communicating and/or transferring two dimensional or three dimensional images to a mobile computing device 770, remote computing devices, and/or other servers. In embodiments, computer-readable instructions 760 executable by one or more processors 730/750 may communicate captured two dimensional or three dimensional images (or image files) to a mobile computing device 770 via a wireless transceiver 765 in a lighting apparatus to a wireless transceiver 775 in a mobile computing device 770. In embodiments, computer-readable instructions 773 executable by the one or more processors 771 in a mobile computing device 770 may store received two dimensional or three dimensional images (or representative files) in one or more memory devices 772 of a mobile computing device 770 for later analysis. In embodiments, computer-readable instructions 773 executable by one or more processors 771 may communicate the received two dimensional or three dimensional images (or associated image files) to a display or screen 774 of a mobile computing device 770 for review by a user or operator (such as for use in real-time monitoring, real-time analysis of plant growth, plant stature and/or plant health, or viewing of a heat profile of an indoor plant). In embodiments, computer-readable instructions 773 executable by one or more processors 771 may analyze the captured and received two dimensional or three dimensional images to determine plant growth, plant stature, and/or plant health. In embodiments, a vision inspection machine may assist in the analyzing the captured and received two dimensional or three dimensional images. In embodiments, computer-readable instructions 773 executable by one or more processors 771 may analyze the captured and received two dimensional or three dimensional images (or associated image files) to determine if the two dimensional or three dimensional images (or associated image files) are acceptable or indicate that plants are healthy and/or growing. In embodiments, these computer-readable instructions may be image processing software that identifies plant structures and compares plant structures and geometries and color to determine whether plant if properly growing, has the right structure and/or is healthy or has diseased leaves. In embodiments, computer-readable instructions executable by one or more processors may also generate a message, instruction and/or command to be sent to a mobile computing device 770 to communicate conditions identified by the image processing software.

A computing device may be a server, a computer, a laptop computer, a mobile computing device, a mobile communications device, and/or a tablet. A computing device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, wearable haptic and touch communication device, a wearable haptic device, a non-wearable computing device having a touch-sensitive display, a remote computing device, a single board computer, and/or an integrated computing device combining various features, such as features of the forgoing devices, or the like.

Electronic device or computing device may also include one or more memory devices that enable data storage, examples of which include random access memory (RAM), non-volatile memory (e.g., read-only memory (ROM), flash memory, EPROM, EEPROM, etc.), and a disk storage device. One or more memory devices may be configured to store instructions and data accessible by processor(s). In embodiments, system memory may be implemented using any suitable memory technology, such as static random access memory (SRAM), dynamic RAM (DRAM), synchronous dynamic RAM (SDRAM), nonvolatile/Flash-type memory, or any other type of memory. One or more memory device(s) provide data storage mechanisms to store the device data, other types of information and/or data, and various device applications (e.g., software applications) (which may be implemented in code or computer-executable instructions). For example, operating system software may be maintained as software instructions within one or more memory devices and executed by processors.

Non-volatile storage medium/media is a computer readable storage medium(s) that can be used to store software and data, e.g., an operating system and one or more application programs, in a computing device or one or more memory devices of an intelligent umbrella and/or robotic shading system. Persistent storage medium/media also be used to store device drivers, (such as one or more of a digital camera driver, motor drivers, speaker drivers, scanner driver, or other hardware device drivers), web pages, content files, metadata, playlists, data captured from one or more assemblies or components (e.g., sensors, cameras, motor assemblies, microphones, audio and/or video reproduction systems) and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in an intelligent shading controller may include or may execute a variety of possible applications, such as a software applications enabling communication with other devices, such as communicating one or more messages such as via email, short message service (SMS), or multimedia message service (MMS), FTP, or other file sharing programs, including via a network, such as a social network, including, for example, Facebook, LinkedIn, Twitter, Instagram, Flickr, or Google+ provide only a few possible examples. A computing device or a processor or controller in a lighting apparatus may also include or execute an application to communicate content, such as, for example, textual content, multimedia content, or the like. A computing device or a processor or controller in a lighting apparatus may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in a lighting apparatus and/or mobile computing device may also include imaging software applications for capturing, processing, modifying and transmitting image, video and/or sound files utilizing the optical device (e.g., camera, scanner, optical reader) within a mobile computing device and/or a lighting apparatus.

Network link typically provides information communication using transmission media through one or more networks to other devices that use or process the information. For example, network link may provide a connection through a network (LAN, WAN, Internet, packet-based or circuit-switched network) to a server, which may be operated by a third party housing and/or hosting service. The server hosts a process that provides services in response to information received over the network, for example, like application, database or storage services. It is contemplated that the components of system can be deployed in various configurations within other computer systems, e.g., host and server.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, DRAM, DDRAM, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

1. An adjustable lighting apparatus for use in indoor growing environments, comprising:
a mounting assembly;
a light emitting diode (LED) assembly to shine light onto one or more plants;
a heat sink, the heat sink coupled to the mounting assembly,
a mounting plate, the mounting plate connected to the LED assembly and the heat sink;
a power supply attached to the heat sink and to provide voltage and current to one or more components;
a sensor to determine a distance between the mounting plate and the one or more plants and communicate the determined distance;
a comparison device to analyze the determined distance to identify if the determined distance is less than a threshold value, and to generate an error signal to identify that the determined distance is less than the predetermined value; and
an indicator to receive the error signal from the comparison device and to display an indication of whether the determined distance is less than the threshold value.

2. The adjustable lighting apparatus of claim 1, the sensor comprising an ultrasonic sensor.

3. The adjustable lighting apparatus of claim 1, the visual indicator comprising a light assembly changing between a green light and a red light.

4. The adjustable lighting apparatus of claim 1, wherein the comparison device is a comparator.

5. The adjustable lighting apparatus of claim 1, wherein the comparison device is a controller, the controller further comprising one or more memory devices, and computer-readable instructions, the computer-readable instructions accessed from the one or more memory devices and executed by the controller to analyze the determined distance to identify if the distance is less than the predetermined value and to generate the error signal.

6. The adjustable lighting apparatus of claim 1, further comprising a distance control assembly, the distance control assembly to adjust a length of the mounting assembly with respect to the indoor plants.

7. The adjustable lighting apparatus of claim 6, wherein the distance control assembly is a knob.

8. The adjustable lighting apparatus of claim 6, wherein the distance control assembly is a switching assembly.

9. A lighting apparatus for use in indoor growing environments, comprising:
a hanging assembly, the hanging assembly being adjustable in length;
a light emitting diode (LED) assembly to project light onto one or more indoor plants;
a mounting plate, the mounting plate to attach to the hanging assembly, the LED assembly to attach to the mounting plate;
a power supply attached to the mounting plate and to provide voltage and current to the LED assembly;
a sensor to determine a distance between the mounting plate and the one or more plants and communicate the determined distance;
a comparison device to analyze the determined distance to identify if the determined distance is outside a pre-determined range, and to generate a signal to identify an out-of-range condition of the one or more indoor plants with respect to the mounting plate;
an indicator to receive the signal identifying the out-of-range condition and to display a visual indicator that an out-of-range condition occurred; and
a motor assembly, the motor assembly to receive the signal from the comparison device and to communicate a signal to the hanging assembly to adjust a length of the hanging assembly.

10. The lighting apparatus of claim 9, the hanging assembly comprising a winch assembly, the winch assembly to receive the signal from the motor assembly to adjust the length of the hanging assembly.

11. The lighting assembly of claim 10, wherein the winch assembly comprises a cable, a spool assembly, wherein the cable is wound around the spool assembly, the spool assembly receiving the signal from the motor assembly to adjust the length of the cable to adjust the length of the hanging assembly.

12. The lighting assembly of claim 9, the comparison device comprising one or more processors, the lighting assembly further comprising one or more memory devices and computer-readable instructions stored in the one or more memory devices, the computer-readable instruction executable by the one or more processors to identify if the determined distance is outside the pre-determined range and to generate the signal to identify the out-of-range condition.

13. The lighting assembly of claim 12, further comprising one or more wireless transceivers, the computer-readable instructions further executable by the one or more processors to communicate messages indicating out-of-range conditions to a mobile computing device via the one or more wireless transceivers.

14. The lighting assembly of claim 13, the computer-readable instructions further executable by the one or more processors to receive messages or instructions from the mobile computing device indicating a movement measurement of the hanging assembly, to generate commands or signals based, at least in part on the received movement measurement and to communicate the commands or signals to the motor assembly to cause the hanging assembly to move a specified distance based at least in part on the movement measurement.

15. The lighting assembly of claim 9, further comprising a temperature sensor, the temperature sensor to capture a temperature measurement in an environment surrounding the lighting assembly and to communicate the temperature measurement,
the comparison device comprising one or more processors, one or more memory devices and computer-readable instructions stored in the one or more memory devices, the computer-readable instructions executable by the one or more processors to receive the temperature measurement, to generate commands or signals and to communicate the commands or signals to the motor assembly to cause the hanging assembly to move a specified distance.

16. The lighting assembly of claim 9, further comprising a humidity sensor, the humidity sensor to capture a humidity measurement in an environment surrounding the lighting assembly and to communicate the humidity measurement,
the comparison device comprising one or more processors, one or more memory devices and computer-readable instructions stored in the one or more memory devices, the computer-readable instructions executable by the one or more processors to receive the humidity measurement, to generate commands or signals and to communicate the commands or signals to the motor assembly to cause the hanging assembly to move a specified distance.

17. The lighting assembly of claim 9, further comprising one or more second distance sensors, the one or more second distance sensors to capture a second distance measurement from the LED assembly to a ceiling of a facility housing the one or more indoor plants and communicate the second distance measurement to the comparison device.

18. The lighting assembly of claim 17, the comparison device comprising one or more processors, one or more memory devices and computer-readable instructions stored in the one or more memory devices, the computer-readable instructions to be executed by the one or more processors to receive the second distance measurement, to generate commands or signals and to communicate the commands or signals to the motor assembly to cause the hanging assembly to move a specified distance.

19. The lighting assembly of claim 9, further comprising one or more imaging devices, the one or more imaging devices to capture video or images of the one or more indoor plants and to communicate the captured video or images.

20. The lighting assembly of claim 19, the comparison device comprising one or more processors, one or more memory devices and computer-readable instructions stored in the one or more memory devices, the computer-readable instructions to be executed by the one or more processors to receive the captured video or images and to communicate the captured video or images to a separate computing device.
